(19) United States
(12) Patent Application Publication
(10) Pub. No.: US 2026/0233762 A1
(43) Pub. Date: Aug. 13, 2026

(54) MEASUREMENT OF DRIVER SIGNAL PERCEPTION IN VEHICLE WITH BRAIN ACTIVITY SENSING

(71) Applicant: Toyota Motor Engineering & Manufacturing North America, Inc., Plano, TX (US)

(72) Inventors: Raymond Peter Viviano, Hazel Park, MI (US); Shailesh Joshi, Ann Arbor, MI (US); Ercan Mehmet Dede, Ann Arbor, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 19/049,768

(22) Filed: Feb. 10, 2025

(51) Int. Cl. B60W 60/00

(52) U.S. Cl. CPC B60W 60/0053; B60W 2420/50; B60W 2540/22

(57) ABSTRACT

A computing system may include a processor. The computing system may include a memory having a set of instructions, which when executed by the processor, cause the computing system to identify a dynamic event occurring in an environment of a vehicle, wherein a user drives the vehicle, determine that the dynamic event meets an intervention criteria, identify user data that includes brain activity of the user in response to the dynamic event meeting the intervention criteria, and generate a prediction of whether the user will respond to the dynamic event within a future time frame based on the user data.

### TECHNICAL FIELD

Examples generally relate to determining whether a vehicle driver comprehends a dynamic event. Some examples may determine whether the driver will have the capacity to respond to the dynamic event in a timely manner based on the comprehension of the driver.

### BACKGROUND

Operating a vehicle may be complicated. For example, a driver of the vehicle may be responsible for executing numerous actions in real time, such as changing lanes, acceleration, deceleration, directions, etc. Compounding the complications is a rising number of distractions. Common distractions include using a phone (texting, calling, etc.), eating or drinking, adjusting the radio, navigating with GPS, talking to passengers, looking at an object outside the car, reaching for items inside the vehicle, applying makeup, and even strong emotions or stress. Any distraction may significantly impact a driver's focus and potentially lead to accidents.

### BRIEF SUMMARY

In some aspects, the techniques described herein relate to a control system including: a processor; and a memory having a set of instructions, which when executed by the processor, cause the control system to: identify a dynamic event occurring in an environment of a vehicle, wherein a user drives the vehicle; determine that the dynamic event meets an intervention criteria; identify user data that includes brain activity of the user in response to the dynamic event meeting the intervention criteria; and generate a prediction of whether the user will respond to the dynamic event within a future time frame based on the user data.

In some aspects, the techniques described herein relate to at least one computer readable storage medium including a set of instructions, which when executed by a computing device, cause the computing device to: identify a dynamic event occurring in an environment of a vehicle, wherein a user drives the vehicle; determine that the dynamic event meets an intervention criteria; identify user data that includes brain activity of the user in response to the dynamic event meeting the intervention criteria; and generate a prediction of whether the user will respond to the dynamic event within a future time frame based on the user data.

In some aspects, the techniques described herein relate to a method including: identifying a dynamic event occurring in an environment of a vehicle, wherein a user drives the vehicle; determining that the dynamic event meets an intervention criteria; identifying user data that includes brain activity of the user in response to the dynamic event meeting the intervention criteria; and generating a prediction of whether the user will respond to the dynamic event within a future time frame based on the user data.

### BRIEF DESCRIPTION OF THE SEVERAL VIEWS OF THE DRAWINGS

The various advantages of the embodiments of the present disclosure will become apparent to one skilled in the art by reading the following specification and appended claims, and by referencing the following drawings, in which:

FIG. 1 is a diagram of a correction process based on brain activity according to an example;

FIG. 2 shows a method of monitoring brain activity and taking a corresponding action according to an example;

FIG. 3 shows a method of training a neural network according to an example;

FIG. 4 shows a vehicle that includes brain activity monitoring and action system according to an example;

FIG. 5 shows a scanning system and monitored portions of a brain according to an example;

FIG. 6 shows a computation process according to an example;

FIG. 7 shows a stop-signal simulation 240 according to an example;

FIG. 8 shows a more detailed example of a diagram of a computing system according to an example;

FIG. 9 shows a method of controlling a vehicle based on brain activity according to an example;

FIG. 10 shows a first continuous wavelet transformation process according to an example;

FIG. 11 shows a second continuous wavelet transformation process according to an example; and

FIG. 12 shows a second continuous wavelet transformation process according to an example.

### DETAILED DESCRIPTION

As noted above, vehicle operation is complicated and is filled with numerous distractions. Accordingly, safety may be impaired. For example, a driver may not notice a dynamic event that warrants attention or is unable to respond to the dynamic event in a timely manner. Safety may be impacted and compromised when dynamic events are unnoticed and a driver therefore fails to respond to the dynamic events. In some cases the dynamic event may go unnoticed by the driver for reasons unrelated to distractions.

Examples herein determine if a vehicle driver comprehended a dynamic signal and/or event. Some examples may determine whether the driver comprehended the signal in a matter of milliseconds (ms) of the event occurring. The vehicle is aware of incoming dynamic signals (e.g., yellow light, railroad, pedestrian, other vehicle) from sensors of the vehicle (e.g., cameras, proximity sensors, light detection and ranging and/or other sensors) as well as the expected road conditions following a signal from coded logic (e.g., red light follows yellow, cars slow to a stop, railroad gates drop following the start of a railroad crossing signal, etc.) to determine if an action is needed. The vehicle may sense the brain activity of the user with different sensors (e.g., electroencephalography sensor, wireless brain sensors, etc.) and techniques (e.g., non-contact electroencephalography). The vehicle determines if a driver comprehended the dynamic signals based on the brain activity and how efficiently the driver processed the information carried by the dynamic signals.

Some previous implementations that utilize brain data are designed to determine if the overall psychological state of a human is one of attention, alertness, boredom, mental overload, or distraction. Rather than estimating an overall psychological state, enhanced examples herein determine how efficiently incoming salient information (e.g., signals of dynamic events) is processed by a human driver. Enhanced examples herein measure specific human information processing.

Some previous examples rely on a “P300 response.” A P300 response may be a measurable reaction to a stimulus. Previous existing examples determine whether the alpha band decreases and the beta band increases about 300 ms after a dynamic event appeared to detect whether a brainwave pattern of interest is exhibited (e.g., indicating surprise and/or recognition of a dynamic event). These previous examples lack the ability to examine changes in activity from specific parts of the brain. That is, enhanced examples herein not only are able to identify the dominance of more generalized brainwave frequencies like alpha, beta, theta, etc., but specifically analyze the different specific parts of the brain. Further, examples may incorporate spectral dynamics which may model a change in power of different frequencies over time (e.g., alpha band, beta band, gamma band, etc.).

Moreover, enhanced examples may detect whether a user will be able to respond to a dynamic event within a predetermined time frame rather than just determining if a user registers a dynamic event. That is, a user may comprehend a dynamic event but be unable to respond to the dynamic event in a timely manner. Examples may determine when such scenarios will occur in the future, and proactively mitigate negative consequences of such dynamic events.

Some previous examples include eye trackers used to infer the direction of human attention. Gaze direction and attention are separable, meaning that attention may be more inward (e.g., memories, daydreaming, etc.) rather than focused on the external environment and/or analyzing signals. Enhanced examples consider attention rather than only gaze, although gaze may also be considered in some examples. Enhanced examples herein do not rely on eye-tracking data to decide on whether a driver comprehended a signal. Such existing examples may include external vehicle sensing and machine vision, but lack the ability to understand whether a driver comprehends an external event.

Current attention detectors may rely on eye-tracking to determine if an individual was looking in the correct direction at the time a stimulus occurred. Enhanced examples consider the spectral dynamics of brain activity to determine how efficiently an individual processed the signal. That is, examples identify a dynamic event occurring in an environment of a vehicle, where a user drives the vehicle, determines that the dynamic event meets an intervention criteria, identifies user data that represents brain activity of the user responsive to the dynamic event meeting the intervention criteria, and generates a prediction of whether the user will respond to the dynamic event within a future time frame based on the user data.

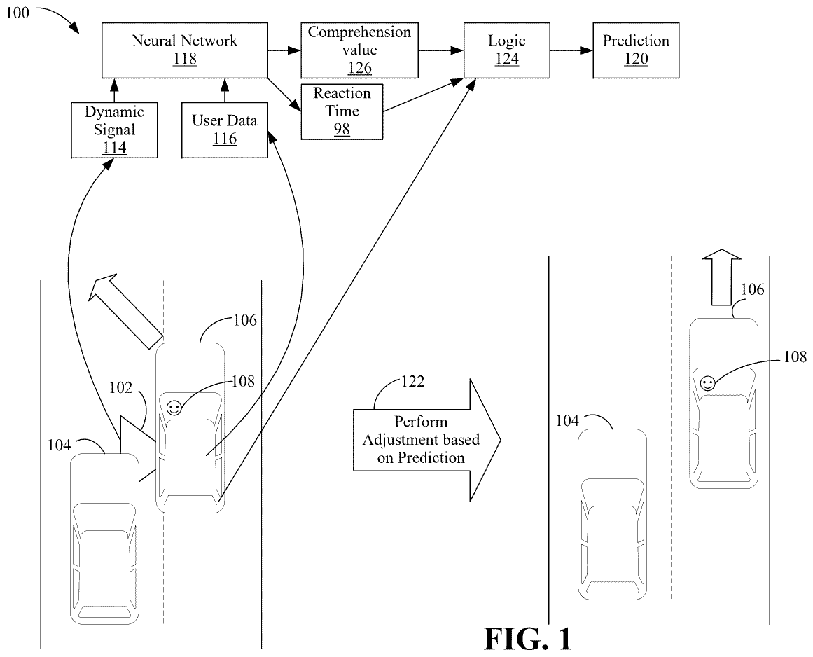

Turning now to FIG. 1, a driver perception and correction process 100 is illustrated. In this example, a driver 108 operates first vehicle 106. The driver 108 may be attempting to switch lanes from the right lane to the left lane. The driver 108 may not have thoroughly checked the blind spot of the first vehicle 106 and/or may have initiated the lane change prior to checking the blind spot. In any case, the driver 108 may not have realized that a second vehicle 104 is directly next to the first vehicle 106 within the blind spot of the first vehicle 106, and therefore that the lane change, if completed, will cause an accident with the second vehicle 104.

In this example, the first vehicle 106 includes sensors (e.g., ultrasonic sensors or corner radar sensors) to detect an area 102 next to the first vehicle 106. The first vehicle 106 may identify whether objects are directly next to the first vehicle 106 and/or in the blind spot of the first vehicle 106. Accordingly, the first vehicle 106 is aware that the second vehicle 104 is in the blind spot of the first vehicle 106. The first vehicle 106 may continuously monitor the environment of the first vehicle 106 and label different parts of the environment based on whether the parts represent a dynamic event (e.g., pedestrian crossing, stop light change, other vehicle positions and movements) that may potentially impact actions (e.g., speed, positioning, movements, etc.) of the first vehicle 106. Dynamic events (events that may impact the first vehicle 106) of the environment may be tagged differently than non-dynamic events (e.g., events that will not affect the first vehicle 106) of the environment. The first vehicle 106 may monitor the dynamic events in real time.

In some examples, the first vehicle 106 may monitor actions of the driver 108. The actions of the driver 108 may indicate an intent of the driver 108. For example, in this example, the driver 108 may turn on the left turn signal indicating the intent of the driver 108 to change lanes. Furthermore, the driver 108 may also be moving the first vehicle 106 into the left lane further confirming that the intent of the driver 108 is to change lanes. Based on the driver 108 combination of actions of the driver 108, the first vehicle 106 may determine that the driver 108 intends to change into the left lane. Thus, in some examples, the first vehicle 106 may use readings from internal systems (e.g., turn signal, steering wheel turning, braking system, imaging sensors, etc.) to identify the intent of the driver 108.

In this example, the sensors of the first vehicle 106 generate a dynamic signal 114 that represents the dynamic event of the environment. For example, the dynamic signal 114 may convey the dynamic event which is the second vehicle 104 being in the blind spot (e.g., a signal from a blind spot monitoring system may be a “dynamic signal”) and any other factors that affect the dynamic event (e.g., speed of the first vehicle 106, position of the first vehicle 106, speed of the second vehicle 104, position of the second vehicle 104, horizonal movement of the first vehicle 106, etc.). The first vehicle 106 may further determine that the dynamic event meets an intervention criteria. The intervention criteria in this example may be if the driver 108 is moving the first vehicle 106 into an object. In this example, the dynamic event meets the intervention criteria since the driver 108 is moving the first vehicle 106 into an object, the second vehicle 104, in the left lane. Accordingly, the dynamic signal 114, indicates that the second vehicle 104 is in the left lane, and the intervention criteria is met by the first vehicle 106 is moving into the left lane. In some examples, the dynamic signal 114 may be an action associated with the second vehicle 104 being in the blind spot, such as a warning, light, etc. being displayed.

The first vehicle 106 identifies user data 116 that represents brain activity of the driver 108 responsive to the dynamic event of the dynamic signal 114 meeting the intervention criteria. That is, the first vehicle 106 may record and store the sensed brain activity of the driver 108. The sensed brain activity may be overwritten and/or deleted after an amount of time (e.g., 10 seconds since the brain activity was sensed).

Once the dynamic event and/or dynamic signal 114 is identified (e.g., lane change with second vehicle 104 in blind spot), a neural network 118 is triggered to analyze the brain activity for a first time period prior to a time that the dynamic event first occurred and/or is detected, and a second time period after the dynamic event first occurred and/or is detected. The first and second time periods may form a window of time that is analyzed. The brain activity for the first and second time periods is analyzed to generate a comprehension value 126 representing a comprehension of the driver 108. Furthermore, the neural network 118 may output a reaction time 98. For example, a first output node of the neural network 118 may provide the comprehension value 126 while a second output node of the neural network 118 may generate the reaction time 98. The reaction time 98 may reflect how long the driver 108 will take to respond to the dynamic event.

The user data 116 includes a first brain activity associated with the first time period prior to the dynamic event occurring, and a second brain activity associated with the second time period after the dynamic event occurs. In some examples, the user data 116 may be converted into a frequency-time domain through a continuous wavelet transformation, and a matrix may be generated based on the conversion of the user data 116 into the frequency-time domain. The neural network 118 may receive the matrix and generate the comprehension value 126 and the reaction time 98 based on the matrix.

The window of the brain activity analyzed may include the starting time of the dynamic signal 114 (e.g., in this case a light flashing from the blind spot monitoring system of the first vehicle 106, second vehicle 104 being detected to be in the blind spot, turn signal being detected, etc.). That is, the starting time for analysis may be when the dynamic signal 114 first appears, or when the gaze of the driver 108 is first directed towards the flashing light. Logic (not illustrated) may determine which start time is more appropriate for a given scenario. If the window of time analyzed is 1000 milliseconds (ms), then the start of the dynamic signal 114 may be at the 500 ms mark within that window of time. The neural network 118 may output comprehension value 126 that indicates how well the driver 108 comprehended that dynamic signal 114. The comprehension value 126 may inform the overall system whether the driver 108 is likely to erroneously continue with the lane change maneuver or not. If the driver 108 never observes the second vehicle 104 and/or the light flashing, in some examples the neural network 118 is not triggered and the first vehicle 106 assumes that the driver 108 will not notice the first vehicle 106 (e.g., executes corrective actions). That is, if the driver 108 never notices the event and/or cause associated with the dynamic signal 114, the neural network 118 may not be triggered.

In some examples, the neural network 118 generates the comprehension value 126 and reaction time 98 based on the brain activity of the user data 116 being transformed. For example, the driver perception and correction process 100 may include executing a spectral dynamics analysis on the brain activity by performing a wavelet transformation on the brain activity to generate transformed brain activity. The neural network 118 may receive the transformed brain activity and process the transformed brain activity to generate comprehension value 126 and reaction time 98.

In this example, the neural network 118 may analyze the brain activity of the driver 108 to provide comprehension value 126 corresponding to how efficiently the driver 108 comprehended the dynamic signal, as well as the reaction time 98. The logic 124 may determine based on the comprehension value 126 and the reaction time 98 whether the second vehicle 104 is recognized by the driver 108, and whether the driver 108 will be able to comprehend the relevance of the second vehicle 104 to the present situation in a timely fashion for response. That is, the neural network 118 may determine the reaction time 98 that is a maximum response time for the driver 108 (e.g., two seconds) to respond to the second vehicle 104 being in the blind spot based on the brain activity. In some examples, if the neural network 118 is unable to determine if the driver 108 notices the second vehicle 104 (e.g., if timing of attention to the external environment and/or dynamic signal is ambiguous), the comprehension value 126 has a corresponding value (e.g., null value) that the logic 124 may interpret to mean the driver 108 will not respond to the second vehicle 104.

In some examples, the logic 124 may determine a future time frame. The future time frame may be a maximum time for the driver 108 and/or the first vehicle 106 to safely adopt corrective measures to mitigate and/or address the dynamic event. For example, the dynamic event may be a dangerous situation, which in this particular case is occurrence of an accident if the first vehicle 106 moves into the left lane. The maximum time may be the latest time for the user driver 108 and/or the first vehicle 106 to maneuver the first vehicle 106 safely away from the left lane and/or cease movement into the left lane and maintain movement in the right lane.

The maximum time may be determined based on a number of factors, including a speed of the first vehicle 106 in the horizontal direction towards the left lane, distance between the second vehicle 104 and the first vehicle 106, etc. That is, the maximum time may be dynamically determined based on factors which are contributing to and/or causing the dynamic event. In some examples, the logic 124 may also include logic that indicates a logical flow of actions (e.g., following a yellow light is a red light, if the first vehicle 106 moves in the left direction at the current velocity and acceleration the first vehicle 106 will reach the left lane in two seconds, etc.). The logic 124 may determine the future time frame based on the various factors noted above, which may also form part of the dynamic signal 114, as well as on the logical flow of actions. Sensor data and/or the factors may be provided to the logic 124 from the first vehicle 106.

In this example, the logic 124 may generate the prediction 120, where the prediction 120 indicates that the driver 108 will not respond to the dynamic event within the future time frame. That is, the neural network 118 may generate the comprehension value 126 and the reaction time 98 (e.g., an estimate of reaction time to the dynamic event) based on the dynamic signal 114 and user data 116 (brain activity during the first and second time periods). The logic 124 receives the comprehension value 126 as well as the reaction time 98 to generate the prediction 120. The reaction time 98 may be compared to the future time frame. If the reaction time 98 is less than the future time frame, the prediction 120 would indicate that the driver 108 will timely respond to the dynamic event and no action is to be undertaken. In this example, the reaction time 98 is greater than the future time frame, so the prediction 120 indicates that the driver 108 will not respond to the dynamic event within the future time frame and an action should be executed.

The neural network 118 and logic 124 may provide enhancements by dynamically responding to a number of different situations and determining the future time frame and the response time of the driver 108. For example, the neural network 118 and logic 124 may be applicable to a number of different scenarios (e.g., stop light changes, pedestrian crossing in front of first vehicle 106, vehicle in front of first vehicle 106 suddenly brakes, etc.) similarly to as described above to determine whether corrective actions should be executed. The logic 124 may also be a neural network.

The first vehicle 106 performs an adjustment based on the prediction 120, 122. In detail, the first vehicle 106 executes an action with the first vehicle 106 based on the prediction 120 indicating that the driver 108 will not respond to the dynamic event within the future time frame. The action may be one or more of automatically decelerating the vehicle to respond to the dynamic event (e.g., dangerous lane change), notifying the driver 108 of the dynamic event (e.g., via a heads-up display, an audio warning, a visual indicator, etc.), or executing an advanced driver assistance system (ADAS) of the vehicle to respond to the dynamic event. The ADAS may be an automated technology that facilitates safety on the road by reducing the risk of accidents and injuries. ADAS may include a variety of functions, such as collision avoidance, lane control, blind spot detection, cruise control among other features. ADAS may also include automatic emergency braking, driver drowsiness detection, and surround view. ADAS may rely on sensors, such as radar, cameras, and ultrasonic sensors, to collect data about the vehicle's surroundings. The system may then use this data to either provide information to the driver or take automatic action.

In this example, the first vehicle 106 automatically maneuvers the first vehicle 106 back into the right lane to mitigate the dynamic event and based on the prediction 120. Thus, the first vehicle 106 acts based on the prediction 120 and overrides the driver 108 intent to change lanes into the left lane by maneuvering the second vehicle 104 into the right lane.

Examples herein may therefore take preventative action and measures when the driver perception and correction process 100 determines that the driver 108 will not respond to the dynamic event in a timely fashion. The first vehicle 106 may adopt actions more efficiently based on brain activity of the driver 108, rather than in situations where the first vehicle 106 takes action based only on external sensor on the first vehicle 106. In doing so, the first vehicle 106 may avoid correcting the first vehicle 106 in situations where the driver 108 will respond to the dynamic event in a timely fashion, enhancing the experience of the driver 108 and increasing safety. That is, hypothetically, if the prediction 120 indicates that driver 108 will respond to the dynamic event within the future time frame to move the first vehicle 106 into the right lane safely, the first vehicle 106 may determine that action is unneeded and avoid assuming autonomous control of the first vehicle 106 (e.g., to automatically move the first vehicle 106 into the right lane).

While a particular scenario relating to lane changes is described above, it will be understood that the driver perception and correction process 100 is equally applicable to nearly any other driving situation. For example, driver perception and correction process 100 may be applied to stop lights. If the neural network 118 and logic 124 determines that the driver 108 will not respond to a changing stop light (e.g., yellow and/or red light) in sufficient time, the first vehicle 106 may generate a notification to warn the driver 108 or assume autonomous control of the first vehicle 106 to slow the first vehicle 106 (decelerate or stop) prior to reaching the stop light. Similarly, the driver perception and correction process 100 may be applied to pedestrians around the first vehicle 106, bicyclists around the first vehicle 106, other vehicles around the first vehicle 106, turn in a roadway, dangerous conditions (e.g., icy roads, potholes, etc.) to control movements of the first vehicle 106 (e.g., move away from pedestrians, bicyclists, ice, etc.), decelerate the first vehicle 106, accelerate the first vehicle 106 and so forth.

It will be understood that the neural network 118 and logic 124 (and any other system) may be implemented as part of a computing system, and include transitory computer readable storage medium, circuitry, configurable logic, fixed-functionality hardware logic, etc., or any combination thereof. The neural network 118 and/or logic 124 may be implemented on the first vehicle 106 and/or executed remotely from the first vehicle 106 on a server (not illustrated) in communication with the first vehicle 106.

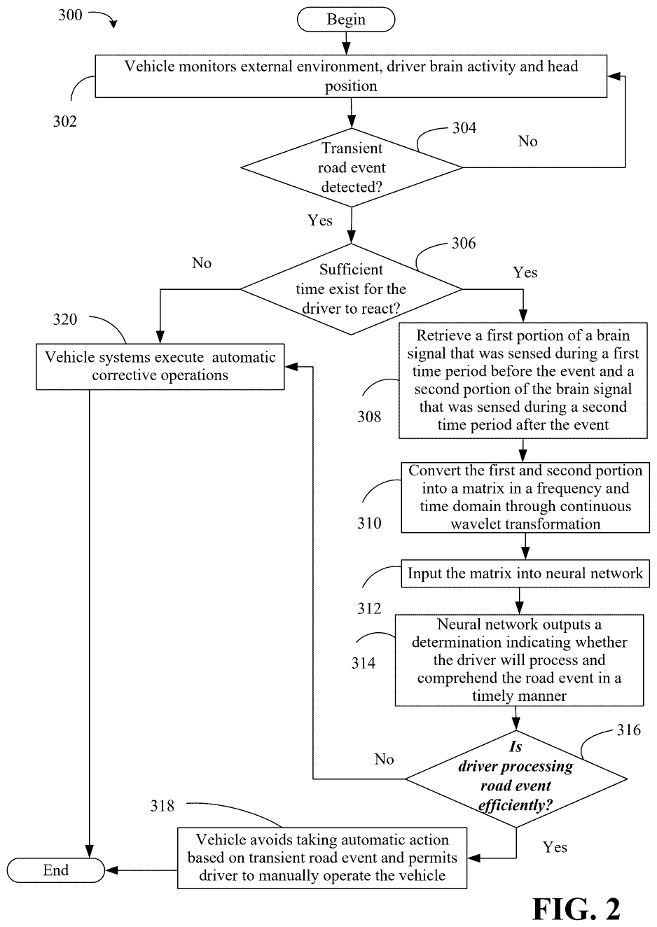

FIG. 2 shows a method 300 of monitoring brain activity of a user, determining when a dynamic event occurs and whether to respond to the dynamic event. The method 300 may generally be implemented as part of the driver perception and correction process 100 (FIG. 1). In an embodiment, the method 300 is implemented in logic instructions (e.g., software), a non-transitory computer readable storage medium, circuitry, configurable logic, fixed-functionality hardware logic, etc., or any combination thereof. In some examples, the first vehicle 106 (FIG. 1) executes the method 300.

Illustrated processing block 302 includes a vehicle monitoring an external environment, driver brain activity and a head position. The head position may be used to determine brain activity. For example, the locations of specific portions of the brain may be tracked through the head position including translation and rotation data of the head. The specific portions may be monitored (e.g., magnetic and/or electrical signals) for brain activity. Furthermore, brain noise (e.g., magnetic and/or electrical signals) from other portions of the brain (that are not relevant for the following analysis and ignored when estimating whether the driver will process and comprehend the road event in a timely manner) and/or environmental noise may be ignored and/or bypassed when determining the brain activity. That is, non-neuronal voltage spikes and frequency information in the collected brain data may be removed and/or corrected. The first vehicle 106 (FIG. 1) may include sensors and logic to execute illustrated processing block 302.

Illustrated processing block 304 determines if a transient road event (e.g., yellow light, red light, pedestrian movement, etc.) is detected. A transient road event may be a part of a dynamic event that impacts the vehicle, merits an autonomous adjustment to the vehicle and/or presents a safety concern. If there is no transient road event, processing block 302 re-executes.

If processing block 304 determines that a transient road event is detected, illustrated processing block 306 determines if sufficient time exists for the driver to react. For example, within about 14 ms a visual signal has traveled from the retina to visual cortex and stimulus processing has begun. A stimulus presented for that amount of time may be at the human perceptual limit. Eye movement upon a visual stimulus flash may take 100 to 140 ms to comprehend. A motor response may take around 200-350 ms. Full comprehension of a stimulus could take 250-400 ms. These ranges account for age and other variables. Reaction to and complete comprehension of a stimulus may occur in parallel, but if comprehension of a stimulus is required for the correct reaction to the stimulus, comprehension and reaction occur serially. In a controlled lab environment where participants are aware that the task is probing reaction time, a user braking in response to a light change occurs around 500-750 ms. A user braking in response to a traffic event may take anywhere between 500 ms to 3000 ms in real world situations and is more likely to take 1500 to 2500 ms. A fully autonomous vehicle may be able to react to a stimulus in only around 100 ms. Examples herein may take around 600-700 ms for the vehicle to determine whether a driver will respond to the stimulus (dynamic event) and react only if needed, which is still shorter than the amount of time the driver in the real word would likely react to such situations. Thus, this system may be an ADAS system incorporated into manual driving to only execute the ADAS processes (e.g., braking, corrective lane adjustment, etc.) to completion if there is not ample time for the human driver to react.

If processing block 306 determines that sufficient time does exist for the driver to react, illustrated processing block 308 retrieves a first portion of a brain signal of the user that was sensed during a first time period before the dynamic event is first identified and a second portion of the brain signal that was sensed during a second time period after the dynamic event is identified. Thus, the brain signal includes a few hundred milliseconds before and after the start time of the dynamic event. Illustrated processing block 310 converts the first and second portion into a matrix in a frequency and time domain through continuous wavelet transformation. The continuous wavelet transform represents a signal in terms of time-frequency content. Conceptually, this is achieved by convolving a signal with scaled and translated versions of a mother wavelet function. The wavelets are localized in frequency and time. One way to consider convolution is as a spectral filter. The squared magnitude of the convolved signal provides information on power over time at the frequency targeted by a specific kernel or wavelet. In practice, the wavelet transformation is computed with Fast Fourier Transformations and Inverse Fast Fourier Transformations as that is quicker than repetitively convolving a signal with different scaled wavelets. Multiplication in the frequency domain is the same as convolution in the time domain. Wavelet transformations are similar to but different from the Short-Time Fourier Transform. The Short-Time Fourier Transform has constant temporal resolution for all frequencies and may be less adaptive to change in signal characteristics.

Illustrated processing block 312 inputs the matrix into a neural network. Illustrated processing block 314 includes the neural network outputting a determination on whether the driver will process and comprehend the road event in a timely manner. Timely manner may mean that the driver understands the dynamic event and will have sufficient time to respond to the dynamic event. In some examples, the driver may not have fully understood the dynamic event when processing block 314 completes. If the neural network predicts that the driver will understand the dynamic event in the future and have sufficient time to respond to the dynamic event to avoid an accident and/or dangerous situation, the neural network determines that the driver will process and comprehend the road event in a timely manner.

Illustrated processing block 316 determines if the driver is processing the road event efficiently based on the determination (e.g., prediction) of the neural network in processing block 314. If so (e.g., the driver is predicted to understand the dynamic event, as well as avoid an accident and/or dangerous situation associated with the dynamic event based on the understanding), illustrated processing block 318 includes the vehicle avoiding taking automatic action based on the transient road event and permits the driver to manually operate the vehicle. Processing block 316 includes determining whether a reaction time of the user will mitigate and/or prevent a poor situation from occurring.

Otherwise, if the driver is not processing the road event efficiently, illustrated processing block 320 includes the vehicle executing automatic corrective action. Processing block 320 may include the autonomous vehicle (AV)/ADAS systems taking over for the vehicle to respond correctly to the road conditions, and/or a vehicle alerting the driver to the situation and AV/ADAS operating to mitigate the accident and/or dangerous situation. Processing block 306 also leads to processing block 320 when sufficient time does not exist for the driver to react. For example, if processing block 306 determines that a dangerous and/or unsafe condition of a dynamic event will occur in 700 ms, processing block 306 may determine that sufficient time does not exist for the driver to react, since the driver will likely take 1500 to 2500 ms to respond to the dangerous and/or unsafe condition.

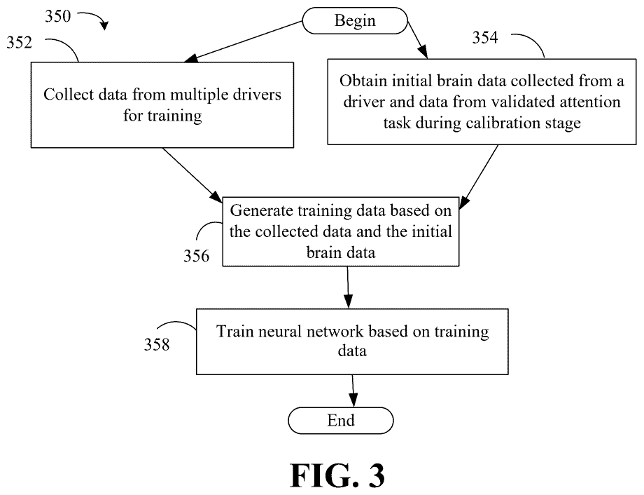

FIG. 3 shows a method 350 of training a neural network used in examples herein. The method 350 may generally be implemented as part of the driver perception and correction process 100 (FIG. 1) and/or method 300 (FIG. 2). In an embodiment, the method 350 is implemented in logic instructions (e.g., software), a non-transitory computer readable storage medium, circuitry, configurable logic, fixed-functionality hardware logic, etc., or any combination thereof.

Illustrated processing block 352 collects data from multiple drivers for training (global variables). Illustrated processing block 354 obtains initial brain data (brain activity) collected from a driver and data from a validated attention task (e.g., stop sign approaching) during a calibration stage (e.g., when vehicle is first purchased). Illustrated processing block 356 generates training data based on the collected data and the initial brain data. Thus, the neural network is trained not only on multiple drivers, but is specifically calibrated for an individual driver brain activity. Illustrated processing block 358 trains the neural network based on the training data.

Data collected from test drivers may be used for initial development of a global neural network model as executed in processing block 352. The initial dataset for model training may include brain data collected during attention tasks in a controlled laboratory setting, brain data collected during driving simulator scenarios, and brain data collected from real-world driving. The global neural network model could be fine-tuned to individual drivers to generate an individualized neural network model by collecting initial brain data during an attention task (e.g., a stop signal task, etc.) during vehicle purchase as shown in processing blocks 354, 356, 358. The global and individualized neural network models may also be iteratively refined to increase prediction accuracy by gathering and storing a subset of driver brain data over time.

Furthermore, in some examples an in-cabin camera may be used to identify who is driving so that an individualized neural net model is used for that specific driver. Accordingly, a first individualized neural network model that is generated during the method 350 may be associated with a first user that participates in processing block 354 at a first time, while a second individualized neural network model that is generated during the method 350 may be associated with a second user that participates in processing block 354 at a second time. The first and second users may be recognized by the vehicle and the corresponding first and second individualized neural network model may be selected and executed. Doing so may enhance efficiency and accuracy.

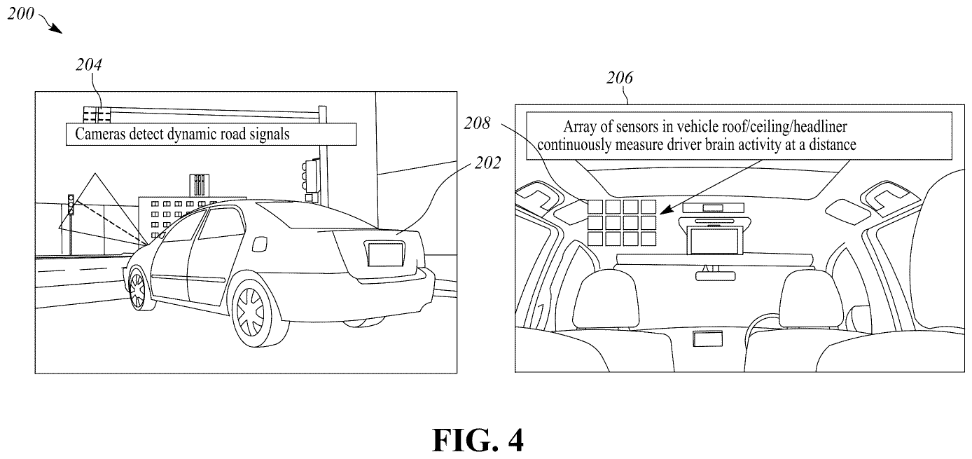

FIG. 4 shows a system 200 that includes driver perceptual processes and structure as described herein. The system 200 may generally be implemented as part of the driver perception and correction process 100 (FIG. 1), method 300 (FIG. 2) and/or method 350 (FIG. 3).

In this example, a vehicle 202 approaches a stoplight 204. Cameras of the vehicle 202 detects dynamic road signals. The interior 206 of the vehicle 202 is shown. The vehicle 202 includes an array of sensors 208 disposed in the roof, ceiling, headrest, and/or headliner to continuously measure driver brain activity at a distance from a driver. Thus, the brain activity of the driver may be measured with the array of sensors 208. The array of sensors 208 may detect magnetic and/or electric fields through induction for example and identify brain activity of the user based on the magnetic and/or electric fields. In some examples, an optically pumped magnetometer quantum sensing device utilizes the interaction of laser light with alkali atoms to detect extremely weak magnetic fields with high sensitivity. The array of sensors 208 may include an optically pumped magnetometer quantum sensing device that senses magnetic fields of the user. Particular portions of the driver's brain may be sensed while others may be ignored or discarded from analysis.

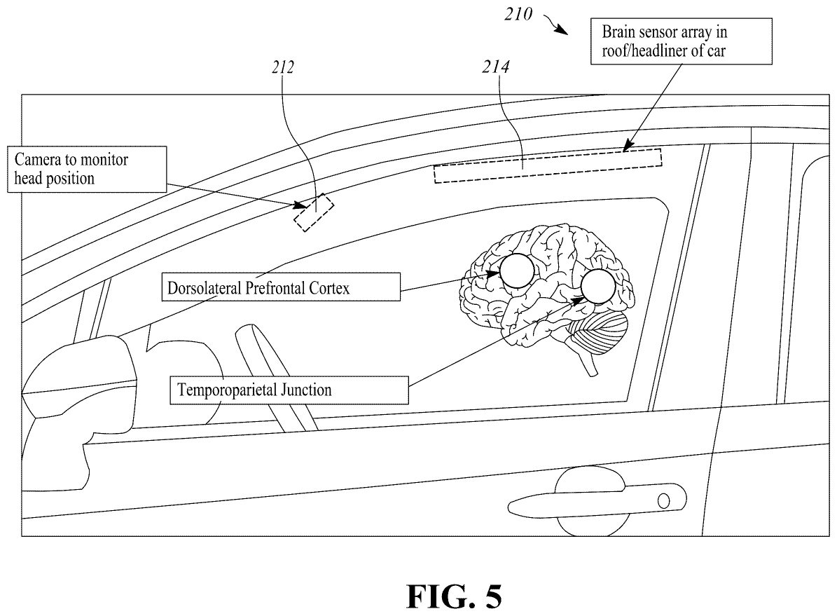

FIG. 5 shows a brain monitoring vehicle 210. The brain monitoring vehicle 210 may generally be implemented as part of the driver perception and correction process 100 (FIG. 1), method 300 (FIG. 2), method 350 (FIG. 3) and/or system 200 (FIG. 4).

The brain monitoring vehicle 210 includes a camera to monitor head position and a brain sensor array 214 in the roof and/or headliner of the brain monitoring vehicle 210. Brain activity of the left and right dorsolateral prefrontal cortex and the left and right temporoparietal junction may be monitored with the brain sensor array 214 to determine whether the user perceives dynamic events and if the user will respond to the dynamic events in a timely fashion. While only the left dorsolateral prefrontal cortex and left temporoparietal junction are illustrated, it will be understood that the brain sensor array 214 may monitor the right dorsolateral prefrontal cortex and the right temporoparietal junction (unillustrated) of the brain. Brain activity from other parts of the brain may be filtered and discarded (e.g., treated as noise) and may not be considered when determining if the user will respond to the dynamic event.

In some examples, a light Electroencephalogram (EEG) neurowearable may also be attached to a head of a user and read brain activity of the user. While brain activity is continuously recorded, when a dynamic signal (e.g., dynamic event) is detected, the system may only use 500 ms of brain activity data prior to the dynamic signal change and 500 ms of the brain activity data following the dynamic signal change to determine how well the driver comprehended the dynamic signal. Specifically, the system uses brain activity data from the left and right dorsolateral prefrontal cortices, as well as brain activity data from the left and right temporoparietal junctions to determine how well the driver comprehended the dynamic signal

The camera 212 monitors driver head position and the brain monitoring vehicle 210 uses the driver head position to estimate the location of the left and right dorsolateral prefrontal cortices and left and right temporoparietal junctions to determine the correct brain signals. That is, the brain sensor array 214 may detect that general brain activity signals originate from first positions in the vehicle. The camera 212 may image the driver concurrently with the brain sensor array 214 detecting the general brain activity. The brain monitoring vehicle 210 may determine that the left and right dorsolateral prefrontal cortices and left and right temporoparietal junctions are at second positions based on the image. The general brain activity is filtered to only include specific brain activity that originates from the second positions (e.g., the second positions are a subset of the first positions) and discards general brain activity outside the second positions. The brain monitoring vehicle 210 then preprocesses the brain activity data (corrects for head motion, removes aberrant voltage spikes from the brain signal data, filters the brain signal data to only contain neuronally-relevant frequency information, and normalizes the data).

Following the preprocessing, the brain monitoring vehicle 210 may transform around 1000 ms (or some other amount of time) of brain activity data for the left and right dorsolateral prefrontal cortices and left and right temporoparietal junctions into time and frequency space with a continuous wavelet transformation. The resulting matrices from this transformation are then compared to known patterns of brain activity (e.g., via a neural network) that indicate efficient or poor information processing of signals on the road. As discussed, a neural network (e.g., deep neural network) may compare the matrices to known patterns of brain activity where the input is the set of matrices from the wavelet transformations and the output is a measure of how well the driver comprehended the road signal. Depending on how well the driver comprehended the road signal, other vehicle systems may take corrective action to alert the driver to the road or automatically brake.

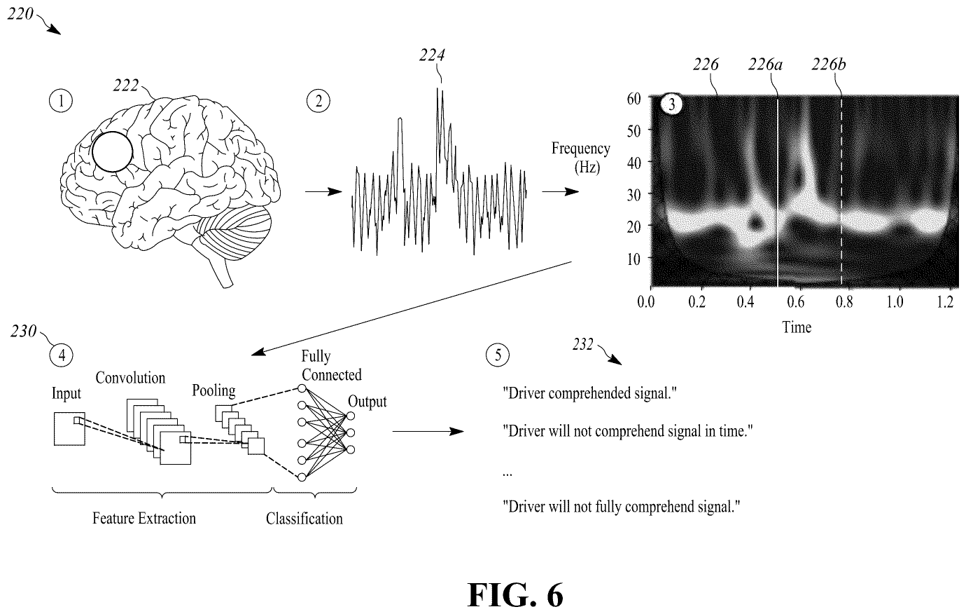

FIG. 6 shows a computation process 220 according to examples herein. The computation process 220 may generally be implemented as part of the driver perception and correction process 100 (FIG. 1), method 300 (FIG. 2), method 350 (FIG. 3), system 200 (FIG. 4) and/or brain monitoring vehicle 210 (FIG. 5).

In this example, brain activity 222 is monitored during a transient road condition (e.g., dynamic signal such as a yellow or red light). Brain activity signal 224 covering the period preceding and following the transient event is preprocessed and normalized. The brain data is transformed into a modified brain data 226 by modifying the brain data into a frequency and time (e.g., frequency by time) domain through a continuous wavelet transformation. Here, the solid lines 226a, 226b indicate when a dynamic signal occurs. The dynamic signal occurs in the external environment and has a clear monitoring start time shown at solid line 226a. The monitoring start time may either be when the dynamic signal first appears or when the driver's fovea is first directed towards the dynamic signal in the external environment. The dynamic signal itself may not be converted into the frequency-time domain. The solid line 226b is the end of the dynamic signal monitoring. A neural net 230 trained on brain activity data in response to transient signals ingests the modified brain data. The neural net 230 outputs a determination 232 of driver likelihood of responding to a road signal in time based on brain activity data when the signal occurred.

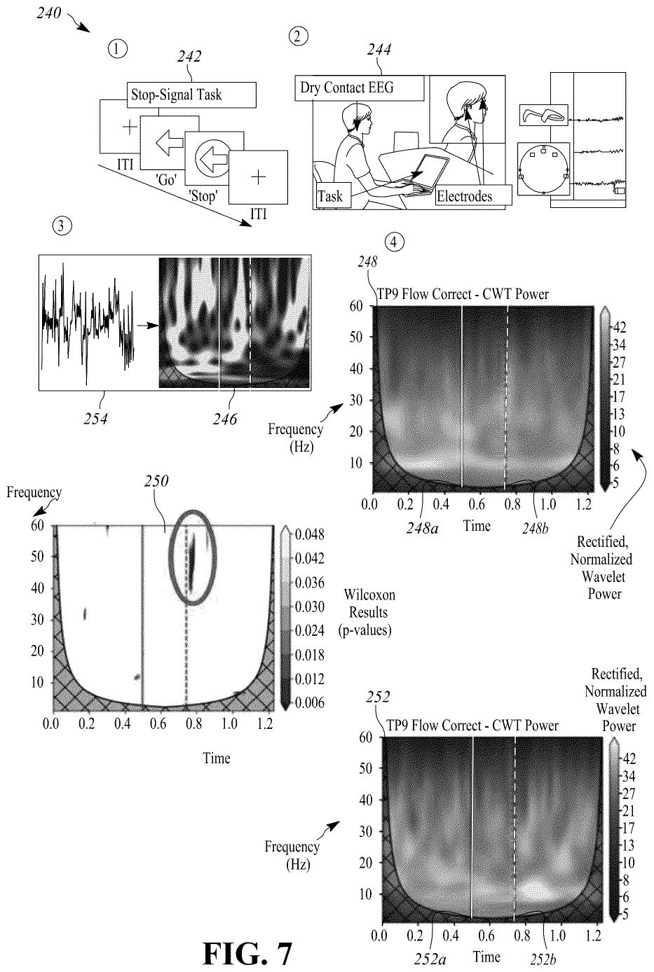

FIG. 7 shows a stop-signal simulation 240 according to examples herein. The stop-signal simulation 240 may generally be implemented as part of the driver perception and correction process 100 (FIG. 1), method 300 (FIG. 2), method 350 (FIG. 3), system 200 (FIG. 4), brain monitoring vehicle 210 (FIG. 5) and/or computation process 220 (FIG. 6).

A stop-signal task 242 is provided. Participants press a key when the word “go” appears on a display. In some trials, a delayed stop sign signal immediately follows where participants inhibit their motor responses. A dry contact EEG 244 is mounted on the user, and is a light neurowearable that measures brain activity during tasks. Several electrodes correspond to dorsolateral prefrontal cortices and temporoparietal junctions at a frequency (e.g., 256 Hz).

A continuous wavelet transform may convert the brain activity 254 into a 2D Time×Frequency signal 246 that is a representation for analyzing spectral dynamics. Graph 248 is an average temporoparietal junction spectral activity when participants responded correctly. The dynamic signal occurs in the external environment and has a clear monitoring start time shown at first solid line 248a. The monitoring start time may either be when the dynamic signal first appears or when the driver's fovea is first directed towards the dynamic signal in the external environment. The dynamic signal itself may not be converted into the frequency-time domain. The dashed line 248b is the end of the dynamic signal monitoring. Graph 252 is an average temporoparietal junction activity when participants responded incorrectly. The dynamic signal occurs in the external environment and has a clear monitoring start time shown at first solid line 252a. The monitoring start time may either be when the dynamic signal first appears or when the driver's fovea is first directed towards the dynamic signal in the external environment. The dynamic signal itself may not be converted into the frequency-time domain. The dashed line 252b is the end of the dynamic signal monitoring. Graph 250 is statistically significant differences between conditions. The data shows a drop in temporal gamma power (30-60 Hz range) around stimulus (e.g., stop signal is shown). Enhanced examples anticipate that gamma frequency range dynamic spectral activity will be a core feature picked up by a neural network that indicates how well a driver will process road signals and how quickly they will respond to them. However, while gamma activity is one of the frequency bands, that are identified as significant, some examples consider all neuronally relevant frequencies (e.g., between 0-80 Hz).

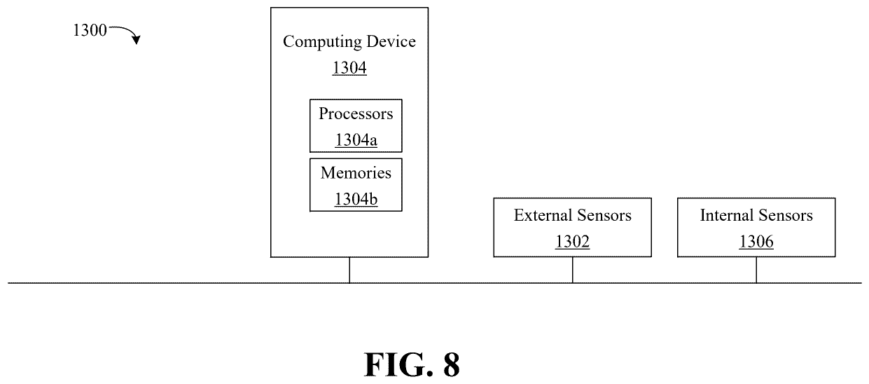

FIG. 8 shows a more detailed example of a vehicle 1300 to implement aspects as described herein. The vehicle 1300 may generally be implemented as part of the driver perception and correction process 100 (FIG. 1), method 300 (FIG. 2), method 350 (FIG. 3), system 200 (FIG. 4), brain monitoring vehicle 210 (FIG. 5), computation process 220 (FIG. 6) and/or stop-signal simulation 240 (FIG. 7).

In the illustrated example, a computing device 1304 includes a processor 1304a (e.g., embedded controller, central processing unit/CPU) and a memory 1304b (e.g., non-volatile memory/NVM and/or volatile memory) containing a set of instructions, which when executed by the processor 1304a, cause the computing device 1304 to implement any of the aspects described herein. For example, the computing device 1304 may obtain external environmental data from external sensors 1302 and detect a dynamic event based on the external environmental data. The computing device 1304 may also determine brain activity of a driver of the vehicle 1300 through the internal sensors 1306. The computing device 1304 may determine whether to execute an automatic action based on the brain activity and the dynamic event as described above.

In the illustrated example, the computing device 1304 includes processors 1304a (e.g., embedded controller, central processing unit/CPU) and memories 1304b (e.g., non-volatile memory/NVM and/or volatile memory) containing a set of instructions, which when executed by the processor 1304a, cause the computing device 1304 to implement any of the aspects described herein.

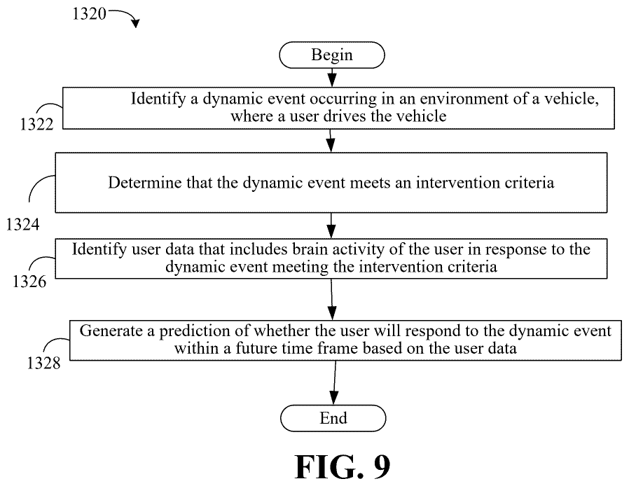

FIG. 9 shows a method 1320 of determining awareness of a user and whether to execute corrective action based on the awareness. The method 1320 may generally be implemented as part of the driver perception and correction process 100 (FIG. 1), method 300 (FIG. 2), method 350 (FIG. 3), system 200 (FIG. 4), brain monitoring vehicle 210 (FIG. 5), computation process 220 (FIG. 6), stop-signal simulation 240 (FIG. 7) and/or vehicle 1300 (FIG. 8). In an embodiment, the method 1320 is implemented in logic instructions (e.g., software), a non-transitory computer readable storage medium, circuitry, configurable logic, fixed-functionality hardware logic, etc., or any combination thereof.

Illustrated processing block 1322 identifies a dynamic event occurring in an environment of a vehicle, where a user drives the vehicle. Illustrated processing block 1324 determines that the dynamic event meets an intervention criteria. Illustrated processing block 1326 identifies user data that includes brain activity of the user in response to the dynamic event meeting the intervention criteria. Illustrated processing block 1328 generates a prediction of whether the user will respond to the dynamic event within a future time frame based on the user data.

In some examples, the method 1320 includes the prediction indicating that the user will not respond to the dynamic event within the future time frame, and executing an action with the vehicle based on the prediction indicating that the user will not respond to the dynamic event within the future time frame. In such examples, the action is one or more of automatically decelerating the vehicle to respond to the dynamic event, notifying the user of the dynamic event, or executing an advanced driver assistance of the vehicle to respond to the dynamic event.

In some examples, the method 1320 includes determining that an action is unneeded when the prediction indicates that the user will respond to the dynamic event within the future time frame. In some examples, the user data includes first brain activity associated with a first time period prior to the dynamic event being identified, and second brain activity associated with a second time period after the dynamic event is identified. In some examples, processing block 1328 includes executing a spectral dynamics analysis on the brain activity by performing a wavelet transformation on the brain activity. In some examples, the method 1320 includes generating a matrix by converting the user data into a frequency and time domain, and analyzing the matrix with a neural network to generate the prediction.

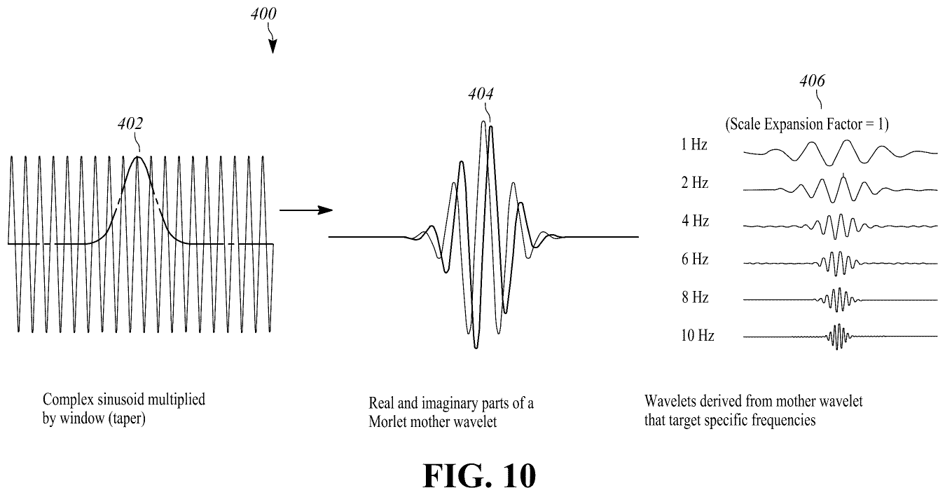

FIG. 10 illustrates a first continuous wavelet transformation process 400. The first continuous wavelet transformation process 400 may generally be implemented as part of the driver perception and correction process 100 (FIG. 1), method 300 (FIG. 2), method 350 (FIG. 3), system 200 (FIG. 4), brain monitoring vehicle 210 (FIG. 5), computation process 220 (FIG. 6), stop-signal simulation 240 (FIG. 7), vehicle 1300 (FIG. 8) and/or method 1320 (FIG. 9). The continuous wavelet transform (CWT) represents a signal in terms of time-frequency content. Conceptually, the CWT is achieved by convolving a signal with scaled and translated versions of a mother wavelet function. These wavelets are localized in frequency and time. One way to consider convolution is as a spectral filter. The squared magnitude of the convolved signal provides information on power over time at the frequency targeted by a specific kernel or wavelet.

As illustrated, a complex sinusoid multiplied by a window (e.g., taper) 402 is generated. The Real and imaginary parts of a Morlet mother wavelet 404 is generated. Wavelets 406 derived from Morlet mother wavelet 404 that target specific frequencies is generated.

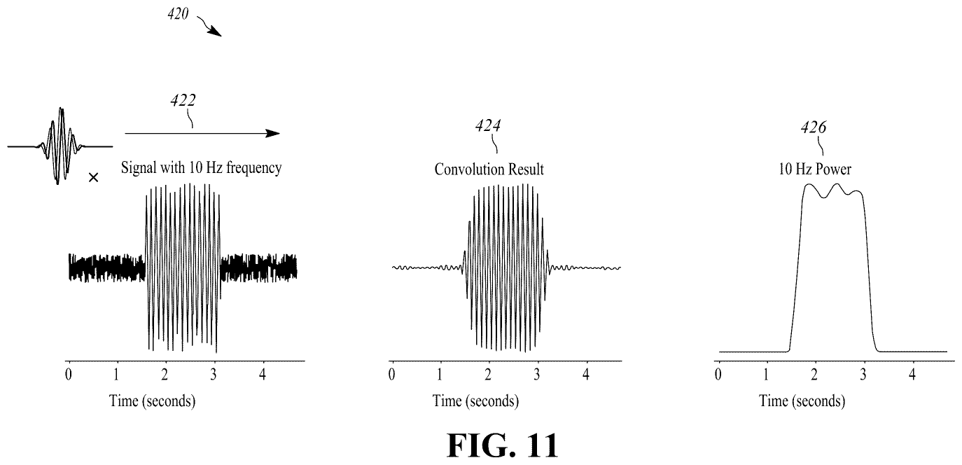

FIG. 11 illustrates a second CWT process 420. The second CWT process 420 may generally be implemented as part of the driver perception and correction process 100 (FIG. 1), method 300 (FIG. 2), method 350 (FIG. 3), system 200 (FIG. 4), brain monitoring vehicle 210 (FIG. 5), computation process 220 (FIG. 6), stop-signal simulation 240 (FIG. 7), vehicle 1300 (FIG. 8), method 1320 (FIG. 9) and/or first continuous wavelet transformation process 400 (FIG. 10).

The CWT represents a signal in terms of time-frequency content. Conceptually, the CWT is achieved by convolving a signal with scaled and translated versions of a mother wavelet function. These wavelets are localized in frequency and time. One way to consider convolution is as a spectral filter. The squared magnitude of the convolved signal provides information on power over time at the frequency targeted by a specific kernel or wavelet.

As illustrated, a signal 422 with 10 Hz frequency is generated. The convolution result 424 is generated. The graph 426 of power indicates that 10 Hz of power is generated.

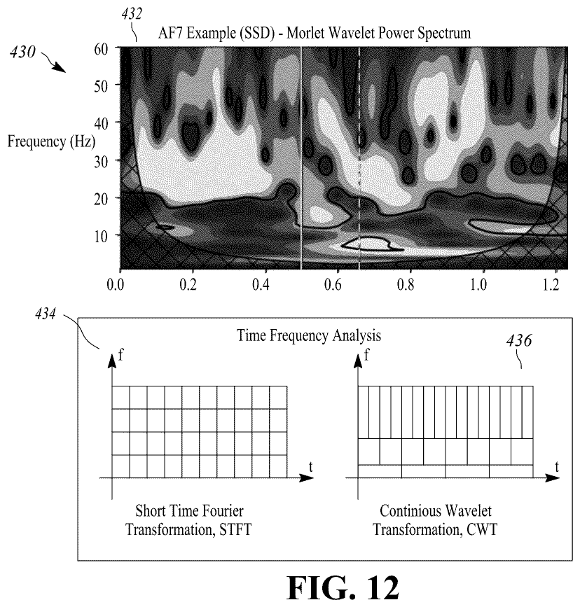

FIG. 12 illustrates a third CWT process 430. The third CWT process 430 may generally be implemented as part of the driver perception and correction process 100 (FIG. 1), method 300 (FIG. 2), method 350 (FIG. 3), system 200 (FIG. 4), brain monitoring vehicle 210 (FIG. 5), computation process 220 (FIG. 6), stop-signal simulation 240 (FIG. 7), vehicle 1300 (FIG. 8), method 1320 (FIG. 9), first continuous wavelet transformation process 400 (FIG. 10) and/or second CWT process 420 (FIG. 10).

The CWT 436 result is a two-dimensional (2D) representation 432 of a signal in the time-scale domain. The magnitude of CWT coefficients indicates the strength of the signal at different frequencies and time positions. The CWT is particularly useful for analyzing electroencephalogram (EEG) signals with dynamic characteristics, where frequency content or band-power change over time. The Short-Time Fourier Transform (STFT) 434 has constant temporal resolution for all frequencies and may be less adaptive to change in signal characteristics. The CWT provides variable time/frequency resolution (better temporal resolution at high frequencies, better spatial resolution at low frequencies).

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present disclosure may be implemented in a variety of forms. Therefore, while the embodiments of this disclosure have been described in connection with particular examples thereof, the true scope of the embodiments of the disclosure should not be so limited since other modifications will become apparent to the skilled practitioner upon a study of the drawings, specification, and following claims.

We claim:

1. A control system comprising:
a processor; and
a memory having a set of instructions, which when executed by the processor, cause the control system to:
identify a dynamic event occurring in an environment of a vehicle, wherein a user drives the vehicle;
determine that the dynamic event meets an intervention criteria;
identify user data that includes brain activity of the user in response to the dynamic event meeting the intervention criteria; and
generate a prediction of whether the user will respond to the dynamic event within a future time frame based on the user data.

2. The control system of claim 1,
wherein the prediction indicates that the user will not respond to the dynamic event within the future time frame,
wherein the instructions of the memory, when executed, cause the control system to:
execute an action with the vehicle based on the prediction indicating that the user will not respond to the dynamic event within the future time frame.

3. The control system of claim 2, wherein the action is one or more of notifying the user of the dynamic event, or executing an advanced driver assistance of the vehicle to respond to the dynamic event.

4. The control system of claim 1, wherein the instructions of the memory, when executed, cause the control system to:
determine that an action is unneeded when the prediction indicates that the user will respond to the dynamic event within the future time frame.

5. The control system of claim 1, wherein the user data includes first brain activity associated with a first time period prior to the dynamic event being identified, and second brain activity associated with a second time period after the dynamic event is identified.

6. The control system of claim 1, wherein to generate the prediction, the instructions of the memory, when executed, cause the control system to execute a spectral dynamics analysis on the brain activity by performing a wavelet transformation on the brain activity.

7. The control system of claim 1, wherein the instructions of the memory, when executed, cause the control system to:
generate a matrix by converting the user data into a frequency and time domain; and
analyze the matrix with a neural network to generate a value representing user comprehension of the dynamic event.

8. At least one computer readable storage medium comprising a set of instructions, which when executed by a computing device, cause the computing device to:
identify a dynamic event occurring in an environment of a vehicle, wherein a user drives the vehicle;
determine that the dynamic event meets an intervention criteria;
identify user data that includes brain activity of the user in response to the dynamic event meeting the intervention criteria; and
generate a prediction of whether the user will respond to the dynamic event within a future time frame based on the user data.

9. The at least one computer readable storage medium of claim 8, wherein the prediction indicates that the user will not respond to the dynamic event within the future time frame,
wherein the instructions, when executed, cause the computing device to:
execute an action with the vehicle based on the prediction indicating that the user will not respond to the dynamic event within the future time frame.

10. The at least one computer readable storage medium of claim 9, wherein the action is one or more of notifying the user of the dynamic event, or executing an advanced driver assistance of the vehicle to respond to the dynamic event.

11. The at least one computer readable storage medium of claim 8, wherein the instructions, when executed, cause the computing device to:
determine that an action is unneeded when the prediction indicates that the user will respond to the dynamic event within the future time frame.

12. The at least one computer readable storage medium of claim 8, wherein the user data includes first brain activity associated with a first time period prior to the dynamic event being identified, and second brain activity associated with a second time period after the dynamic event is identified.

13. The at least one computer readable storage medium of claim 8, wherein to generate the prediction, wherein the instructions, when executed, cause the computing device to execute a spectral dynamics analysis on the brain activity by performing a wavelet transformation on the brain activity.

14. The at least one computer readable storage medium of claim 8, wherein the instructions, when executed, cause the computing device to:
generate a matrix by converting the user data into a frequency and time domain; and
analyze the matrix with a neural network to generate a value representing user comprehension of the dynamic event.

15. A method comprising:
identifying a dynamic event occurring in an environment of a vehicle, wherein a user drives the vehicle;
determining that the dynamic event meets an intervention criteria;
identifying user data that includes brain activity of the user in response to the dynamic event meeting the intervention criteria; and
generating a prediction of whether the user will respond to the dynamic event within a future time frame based on the user data.

16. The method of claim 15, wherein the prediction indicates that the user will not respond to the dynamic event within the future time frame,
the method further includes:
executing an action with the vehicle based on the prediction indicating that the user will not respond to the dynamic event within the future time frame.

17. The method of claim 16, wherein the action is one or more of notifying the user of the dynamic event, or executing an advanced driver assistance of the vehicle to respond to the dynamic event.

18. The method of claim 15, further comprising:
determining that an action is unneeded when the prediction indicates that the user will respond to the dynamic event within the future time frame.

19. The method of claim 15, wherein the user data includes first brain activity associated with a first time period prior to the dynamic event being identified, and second brain activity associated with a second time period after the dynamic event is identified.

20. The method of claim 15, wherein the generating the prediction includes executing a spectral dynamics analysis on the brain activity by performing a wavelet transformation on the brain activity.
